(19) United States
(12) Patent Application Publication
(10) Pub. No.: US 2026/0223819 A1
(43) Pub. Date: Aug. 6, 2026

(54) SMALL MAMMAL FEEDING STATION

(71) Applicant: Wisdom Good Bites, LLC, Flagstaff, AZ (US)

(72) Inventors: Sheila Jeanette Mosher, Gilbert, AZ (US); Cheryl Dyer, Flagstaff, AZ (US); Melissa Polen, Flagstaff, AZ (US); Alaina Gonzalez-White, Astoria, NY (US)

(73) Assignee: Wisdom Good Bites, LLC, Flagstaff, AZ (US)

(21) Appl. No.: 19/464,529

(22) Filed: Jan. 29, 2026

Related U.S. Application Data
(60) Provisional application No. 63/752,545, filed on Jan. 31, 2025.

(51) Int. Cl. A01K 21/00; A01K 5/02; A61D 7/00

(52) U.S. Cl. CPC A01K 21/00; A01K 5/0225; A61D 7/00

(57) ABSTRACT

A feeding station includes an enclosure, a feeding tray disposed within the enclosure and a refillable hopper disposed within the enclosure and configured to supply the feeding tray with fertility control feed. Openings within the enclosure allow access into the enclosure for a target species whilst excluding access into the enclosure for a non-target species. As such, the target species are guided through the openings toward the feeding tray where the target species eat the fertility control feed. As the feeding tray empties, the refillable hopper refills the feeding tray, enabling delivery of the fertility control feed to the target species on a recurring basis, rather than a single delivery of pest control product.

### CROSS-REFERENCE TO RELATED APPLICATION

The present application is related to and claims priority to U.S. Provisional Patent Application Number 63/752,545 filed January 31, 2025, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of pest management systems of existing art and more specifically relates to a feeding station for controlled delivery of fertility control feeds to target small mammal pest species.

### RELATED ART

Conventional pest management systems for small mammals typically employ poison-based baits. These traditional systems are predicated on a single-delivery model wherein a lethal dose of poison is administered to the target species.

Recent developments in pest management have introduced non-poisonous fertility control feed products as an alternative to conventional poison baits. These fertility control feeds, which may be formulated as pellets or similar feed forms, represent a shift from lethal poison bait blocks and other poisonous bait formats. However, the implementation of fertility control methodologies presents distinct operational requirements that differ fundamentally from traditional poison-based approaches.

In particular, unlike poison baits that require only a single exposure, fertility control feeds necessitate recurring administration over extended periods to achieve efficacy. This recurring delivery model more closely resembles traditional animal feeding regimens rather than the one-time deployment characteristic of poison-based systems.

Consequently, existing delivery systems designed for poison baits are inadequate for the effective administration of fertility control feeds. Current feeding station designs do not adequately address the combination of these requirements necessary for effective long-term delivery of fertility control feeds to small mammal pest species.

Accordingly, there exists a need in the art for an improved feeding station specifically designed to meet the unique delivery requirements of fertility control feed products for pest management applications.

### SUMMARY OF THE INVENTION

In view of the foregoing disadvantages inherent in the known pest management art, the present disclosure provides a novel small mammal feeding station. The general purpose of the present disclosure, which will be described subsequently in greater detail, is to provide a feeding station that provides controlled dispensing of fertility control feed to ensure appropriate dosing and provides exclusion of non-target animal species to ensure that only the intended pest species has access to the fertility control feed.

A feeding station is disclosed herein. According to one or more embodiments, the feeding station may comprise an enclosure including at least one opening sized to allow access into the enclosure for a target species whilst excluding access into the enclosure for a non-target species, a feeding tray housed within the enclosure and a refillable hopper housed within the enclosure, the refillable hopper in communication with the feeding tray and configured to dispense fertility control feed into the feeding tray.

According to one or more additional embodiments, a feeding station may include an enclosure including an enclosure base, an enclosure top, at least one opening within the enclosure base and at least one anchoring structure for securing the enclosure to an external element; at least one reinforced entry frame configured to attach to the at least one opening of the enclosure, the at least one reinforced entry frame sized to allow access into the enclosure for a target species whilst excluding access into the enclosure for a non-target species; a feeding tray housed within the enclosure; and a refillable hopper housed within the enclosure, the refillable hopper in communication with the feeding tray and configured to dispense fertility control feed into the feeding tray.

According to one or more additional embodiments still, a method of delivering fertility control feed to a target species is disclosed herein. The method may comprise the steps of: providing a feeding station as above; filling the refillable hopper with the fertility control feed; and dispensing the fertility control feed into the feeding tray. The target species are guided through the at least one opening toward the feeding tray where the target species eat the fertility control feed, and, as the feeding tray empties, the refillable hopper refills the feeding tray, enabling delivery of the fertility control feed to the target species on a recurring basis.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a small mammal feeding station, constructed and operative according to the teachings of the present disclosure.

FIG. 1 is a side perspective view of a feeding station comprising an enclosure including an enclosure base and a refillable hopper, according to an embodiment of the disclosure.

FIG. 2 is a top perspective view of the enclosure including the enclosure base and an enclosure top, according to an embodiment of the present disclosure.

FIG. 3 is a perspective view of a plurality of entry frames, according to an embodiment of the present disclosure.

FIG. 4 is a side perspective of the refillable hopper, according to an embodiment of the present disclosure.

FIG. 5 is a cutaway view of the feeding station showing the refillable hopper feeding into a feeding tray, according to an embodiment of the present disclosure.

FIG. 6 is a top perspective view of a tray housing a motion activated camera system for installation in the enclosure, according to an embodiment of the present disclosure.

FIG. 7 is a schematic diagram of the motion activated camera system, according to an embodiment of the present disclosure.

FIG. 8 is a top perspective view of a force sensor disposed in a bottom of the enclosure, according to an embodiment of the present disclosure.

FIG. 9 is a flow diagram illustrating a method of delivering fertility control feed to a target species, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to pest management and more particularly to a small mammal feeding station. Generally, the small mammal feeding station comprises a hopper structure within an enclosure which dispenses fertility control feed. Key features of the feeding station include a removable and refillable feed hopper, elevation from ground level for protection from water seepage, variable-sized entry frames to tailor exclusion of non-target species and an optional motion-activated camera component to assist in monitoring activity. An optional force sensor may be inserted beneath the removable hopper for additional activity monitoring.

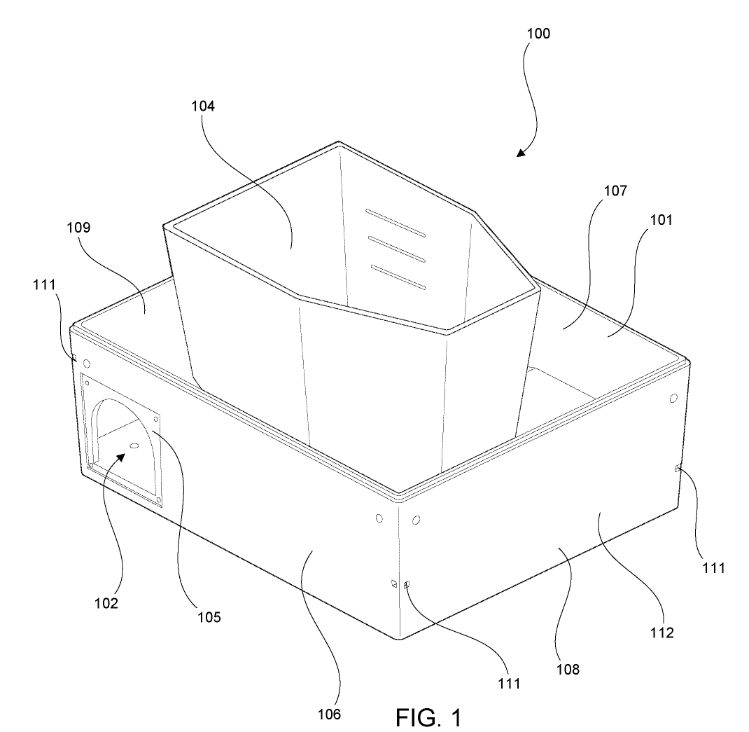

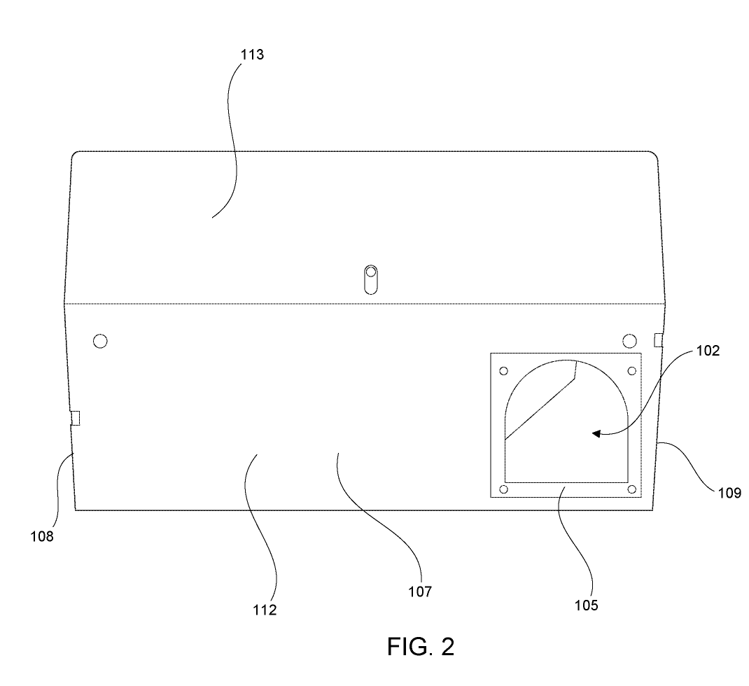

Referring now more specifically to the drawings by numerals of reference, there is shown in FIGS. 1-8, various views of a feeding station 100, according to one or more embodiments of the present disclosure. Referring first to FIGS. 1-2, there is shown a side perspective view of the feeding station 100 (FIG. 1) and a side perspective view of the feeding station 100 (FIG. 2). As shown here, the feeding station 100 may comprise an enclosure 101 and a refillable hopper 104 housed within the enclosure 101. Preferably, the enclosure 101 includes an enclosure base 112 and an enclosure top 113. In FIG. 2, the enclosure top 113 is shown attached over the enclosure base 112, forming the enclosure 101. In some embodiments, the enclosure top 113 may be hinged to the enclosure base 112. In a non-limiting example, the enclosure top 113 may be hinged to the enclosure base 112 at the first end 108 of the closure. In other embodiments, the enclosure top 113 may be fully removable from the enclosure base 112.

The feeding station 100 is preferably tamper-resistant. For example, the enclosure top 113 may be secured to the enclosure base 112 via a locking mechanism. In a non-limiting example, the locking mechanism may include a bolt and embedded threaded insert. In some embodiments, the locking mechanism may be created via print-in-place 3D printing.

The enclosure 101 may include at least one opening 102 sized to allow access into the enclosure 101 for a target species, whilst excluding access into the enclosure 101 for a non-target species. Non-limiting examples of target species may include small mammals such as rats, mice, squirrels, pigeons, raccoons, opossums, etc. Non-target species can include any species that a user does not want to be fed fertility control feed. Non-limiting examples may include domestic pets, livestock, endangered species, etc.

As such, the at least one opening 102 includes a size that is only big enough to allow the target species in and is too small to allow the non-target species in – ensuring that the non-target species do not consume the fertility control feed. In some embodiments, as shown here, the feeding station 100 may further comprise at least one reinforced entry frame 105 configured to attach to the at least one opening 102 of the enclosure 101. As such, in some embodiments, the at least one reinforced entry frame 105 may include the dimensions to allow access into the enclosure 101 for the target species whilst excluding access into the enclosure 101 for the non-target species.

Preferably, the enclosure 101 may include two openings 102. The two openings 102 may be disposed at opposite fist and second parallel sides 106, 107 of the enclosure 101, at a first end 108 of the enclosure 101. The positioning of the two openings 102 creates a tunnel view through the enclosure 101, as demonstrated in FIG. 2.

In some embodiments, the feeding station 100 may further comprise at least one anchoring structure 111 located on the enclosure 101 for securing the enclosure 101 to an external element, such as (but not limited to) posts, stakes, and fences. In particular, the at least one anchoring structure 111 may include a plurality of anchoring structures 111, one of the plurality of anchoring structures 111 located on each corner of the enclosure 101 (or proximal thereto). As shown here, in some embodiments, the plurality of anchoring structures 111 may include eyelets. In some embodiments, additional anchoring structures 111 may be included – for example, channels that traverse a bottom of the enclosure 101 to provide a means to strap the enclosure 101 to a weighted concrete block, paver, or the like. The enclosure 101 preferably includes weatherproofing to protect the fertility control feed from external elements.

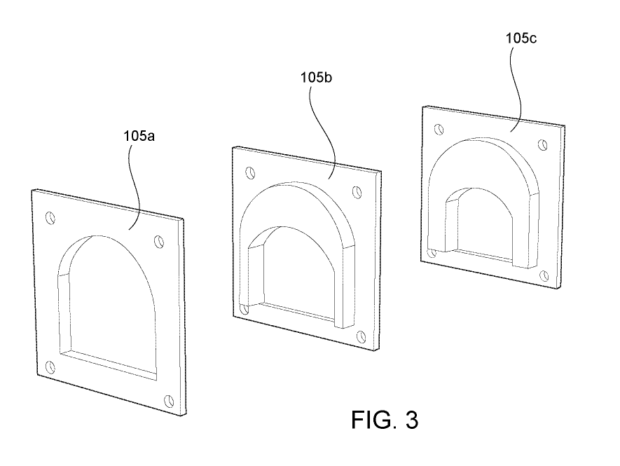

FIG. 3 illustrates a perspective view of a plurality of interchangeable entry frames 105, according to one more embodiment of the present disclosure. As above, the feeding station 100 may further comprise at least one reinforced entry frame 105 configured to attach to the at least one opening 102 of the enclosure 101. In some embodiments, the at least one reinforced entry frame 105 may include a plurality of interchangeable entry frames 105 – each of the plurality of interchangeable entry frames 105 include different sizes/dimensions for enabling access into the enclosure 101 for various sizes of target species. For example, one of the entry frames 105 may be sized only to enable access for field mice, another of entry frames 105 may be sized only to enable access for rats, etc. The entry frames 105 may preferably be reinforced to prevent gnawing, which in turn prevents enlargement of the entry frames 105 and potential entry for non-target species. For example, an entirety of the entry frames 105 may include reinforced material. In another example, a perimeter of the entry frames 105 may include reinforced material.

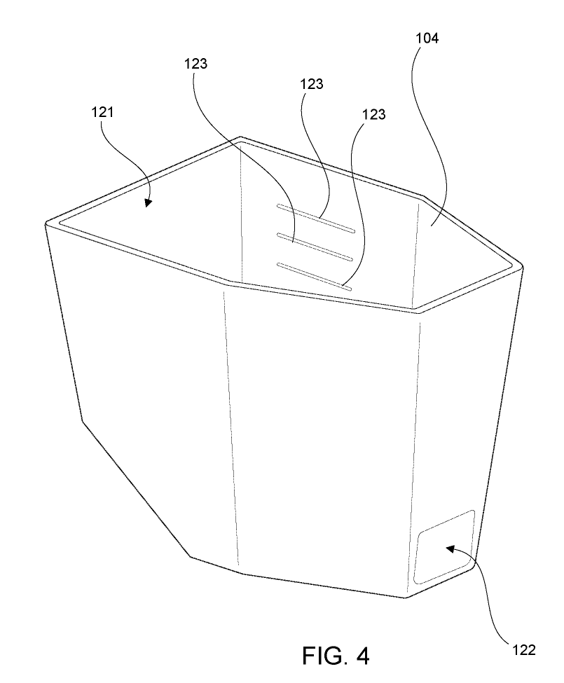

Referring now also to FIG. 4, which shows a side perspective of the refillable hopper 104, the refillable hopper 104 having been removed from the enclosure 101. In some embodiments, as shown here, the refillable hopper 104 may be removable from the enclosure 101. In other embodiments, the refillable hopper 104 may be fixed within the enclosure 101.

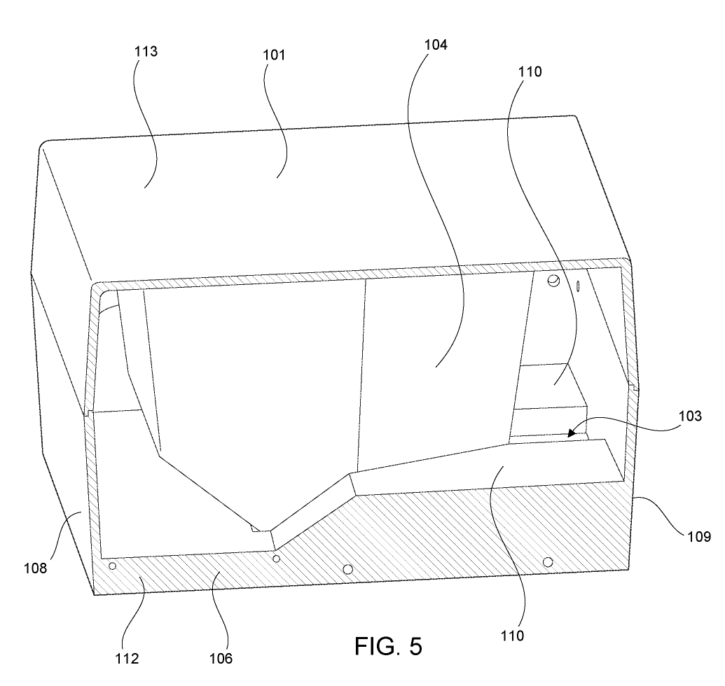

The refillable hopper 104 is configured to be filled with fertility control feed and deliver the fertility control feed into a feeding tray 103 (FIG. 5) housed within the enclosure 101. In some embodiments, the fertility control feed may include pellets. The refillable hopper 104 may include a top opening 121 enabling refilling thereof and a bottom opening 122 in communication with the feeding tray 103 (e.g., directly adjacent to the feeding tray 103 such that fertility control feed is delivered directly into the feeding tray 103 from the refillable hopper 104). In some embodiments, as shown here, the refillable hopper 104 may be marked with a graduated scale 123 to indicate fill level of the refillable hopper 104, enabling a user to easily and quickly ascertain the amount of the fertility control feed within the refillable hopper 104.

Referring now to FIG. 5 , which shows a cutaway view of the feeding station 100, according to one or more embodiments of the present disclosure. As above, the feeding tray 103 may be housed within the enclosure 101. In particular, as shown in FIG. 5, the feeding tray 103 may be disposed at a second end 109 of the enclosure 101, opposite the two openings 102 (disposed at the first end 108 of the enclosure 101). As shown here, the feeding station 100 further comprises two ramps 110 housed within the enclosure 101. In particular, each ramp 110 is disposed at opposite first and second sides 106, 107 of the enclosure 101, connecting each opening 102 to the feeding tray 103. As such, the target species are guided toward the feeding tray 103 from the openings 102, ensuring the target species eat the fertility control feed. As shown here, the two ramps 110 may form a seat 124 for the refillable hopper 104 to insert into.

As the fertility control feed in the feeding tray 103 is eaten and the feeding tray 103 empties, the refillable hopper 104 refills the feeding tray 103. This enables delivery of the fertility control feed to the target species on a recurring basis, rather than a single delivery of pest control product (e.g., poison). Once the refillable hopper 104 reaches a low level, it is refilled, ensuring that the feeding tray 103 is always filled with fertility control feed, again ensuring delivery of the fertility control feed to the target species on a recurring basis.

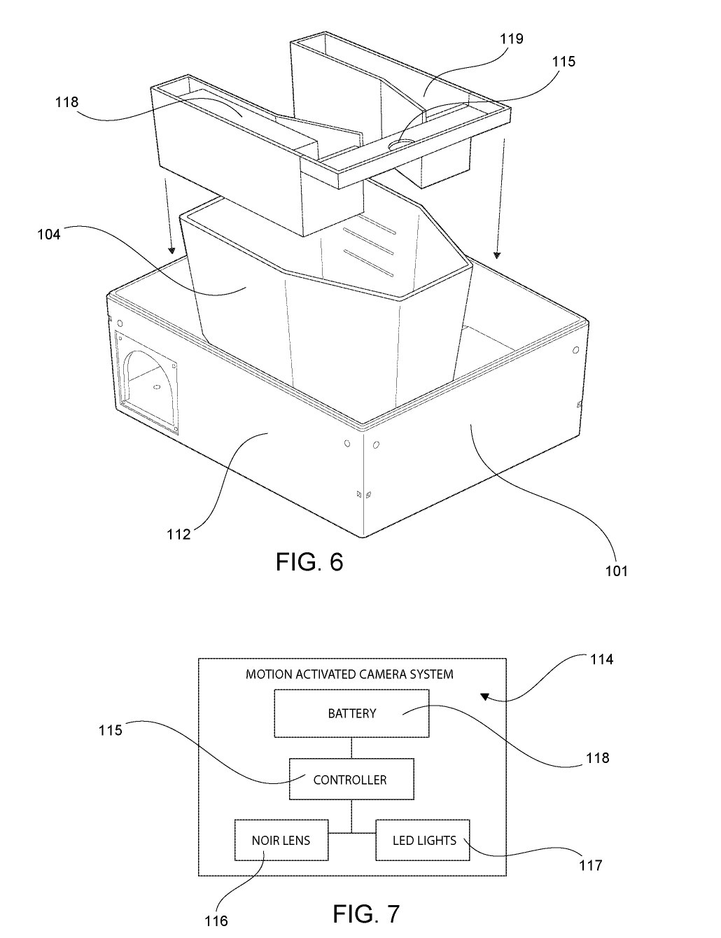

Referring now to FIGS. 6-8, there are shown various views of additional monitoring features which may be included with the feeding station 100. Beginning first with FIGS. 6-7, which shows a top perspective view of a motion activated camera system 114 disposed within the enclosure 101 (FIG. 6) and a schematic diagram of high level components of the motion activated camera system 114 (FIG. 7). The motion activated camera system 114 is configured to monitor activity within the enclosure 101. In particular, in some embodiments, the feeding station 100 may comprise a removable tray 119 housed/configured to be inserted into the enclosure 101, and the motion activated camera system 114 may be housed within the removable tray 119. As particularly shown in the schematic diagram of FIG. 7, the motion activated camera system 114 may include a microcontroller 115, a NoIR lens 116, near-infrared LED lights 117 and a battery pack 118.

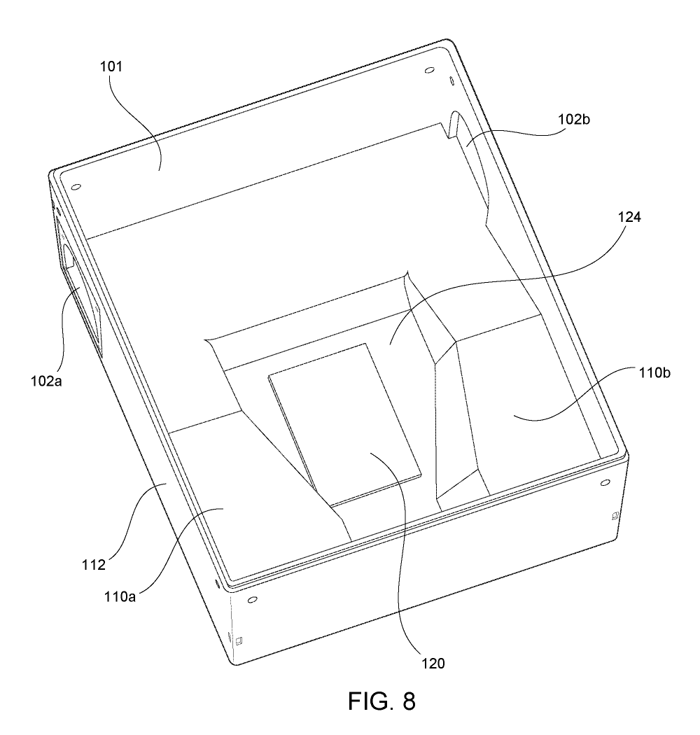

Referring now to FIG. 8, which is a top perspective view of a force sensor 120. As shown here, the force sensor 120 may be disposed in the bottom of the enclosure 101, within the seat 124 formed by the two ramps 110. As such, the force sensor 120 is located underneath the refillable hopper 104 and configured to monitor a weight of the fertility control feed within the refillable hopper 104. In some embodiments, the force sensor 120 may be configured to transmit sensor data over a communication network (e.g., BLUETOOTH®, ZIGBEE®, WIFI®, etc.) to an external device (e.g., a smartphone, a desktop computer, a tablet computer, a laptop computer, etc.). As such, a user of the external device is able to receive updates regarding fertility control feed level, consumption, and efficacy. In a non-limiting example, the external device may receive push notifications, alerts from a software application provided in a wider feeding station 100 system, text messages, email alerts, etc. The ability to monitor the level of the fertility control feed within the refillable hopper 104 ensures that delivery of the fertility control feed to the target species on a recurring basis, rather than a single delivery of pest control product.

As also shown here, and as discussed above, each ramp 110 is disposed at opposite first and second sides 106, 107 of the enclosure 101, connecting each opening 102 to the feeding tray 103 (i.e., ramp 110 a connects opening 102 a to the feeding tray 103 and ramp 110 b connects opening 102 b to the feeding tray 103).

It is anticipated that the enclosure 101, with a fully filled hopper 104, will be placed in areas where pest management is required. It may be secured to a non-movable object to prevent large mammal interference. The enclosure 101 will then be serviced on a regular basis to refill the hopper 104, replace the entry frames 105 if needed, and secure, as necessary.

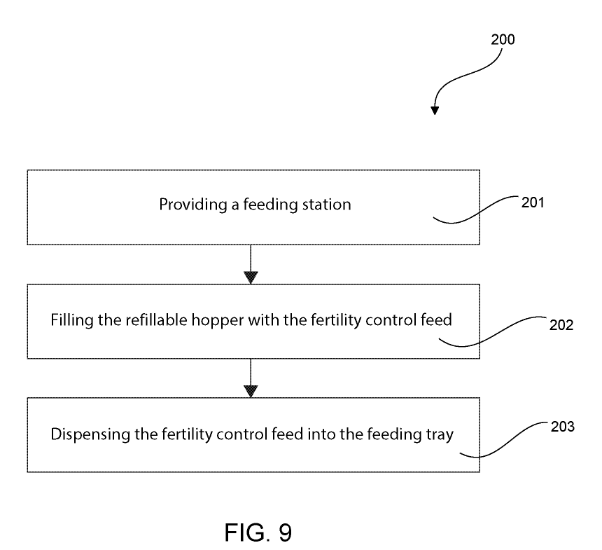

Referring now to FIG. 9 showing a flow diagram illustrating a method of delivering fertility control feed to a target species 200. In particular, the method of delivering fertility control feed to a target species 200 may include one or more components or features of the feeding station 100 as described above. As illustrated, the method of delivering fertility control feed to a target species 200 may include the steps of: step 201, providing a feeding station as above; step 202, filling the refillable hopper with the fertility control feed; and step 203, dispensing the fertility control feed into the feeding tray. As above, the target species are guided through the openings toward the feeding tray where the target species eat the fertility control feed, and, as the feeding tray empties, the refillable hopper refills the feeding tray, enabling delivery of the fertility control feed to the target species on a recurring basis. As also discussed above, once the fertility control feed within the refillable hopper gets low, a user refills the refillable hopper with fertility control feed, thereby replenishing the feeding tray.

As also discussed above, in some embodiments, the feeding station includes one or more anchoring structures located on the enclosure. As such, the method of delivering fertility control feed to a target species 200 may further comprise securing the enclosure to an external element via the at least one anchoring structure.

It should be noted that the steps described in the method of use can be carried out in many different orders according to user preference. The use of "step of" should not be interpreted as "step for", in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for delivering fertility control feed to a target species are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the relevant patent offices and the public generally, and especially the scientist, engineers and practitioners in the art who are not familiar with patent or legal terms or phraseology, to determine quickly from a cursory inspection the nature and essence of the technical disclosure of the application.

What is claimed is:

1. A feeding station comprising:
an enclosure, the enclosure including at least one opening sized to allow access into the enclosure for a target species whilst excluding access into the enclosure for a non-target species;
a feeding tray housed within the enclosure; and
a refillable hopper housed within the enclosure, the refillable hopper in communication with the feeding tray and configured to dispense fertility control feed into the feeding tray.

2. The feeding station of claim 1, further comprising a plurality of interchangeable entry frames configured to attach to the at least one opening, wherein each of the plurality of interchangeable entry frames are sized differently to allow access into the enclosure for variously sized said target species.

3. The feeding station of claim 2, wherein each of the plurality of interchangeable entry frames are reinforced.

4. The feeding station of claim 1, wherein the enclosure includes two openings disposed at opposite first and second sides of the enclosure at a first end of the enclosure.

5. The feeding station of claim 4, wherein the feeding tray is disposed at a second end of the enclosure, opposite the two openings.

6. The feeding station of claim 5, further comprising two ramps disposed within the enclosure at opposite said first and second sides of the enclosure, the two ramps each connecting one of the two openings to the feeding tray.

7. The feeding station of claim 1, further comprising at least one anchoring structure located on the enclosure for securing the enclosure to an external element.

8. The feeding station of claim 1, wherein the enclosure includes an enclosure base and an enclosure top.

9. The feeding station of claim 1, further comprising a motion activated camera system disposed within the enclosure and configured to monitor activity within the enclosure.

10. The feeding station of claim 9, wherein the motion activated camera system includes a microcontroller, a NoIR lens, near-infrared LED lights, and a battery pack.

11. The feeding station of claim 10, further comprising a removable tray for insertion into the enclosure, and wherein the motion activated camera system is housed within the removable tray.

12. The feeding station of claim 1, further comprising a force sensor disposed underneath the refillable hopper to monitor a weight of the feed within the refillable hopper.

13. The feeding station of claim 12, wherein the force sensor is configured to transmit sensor data over a communication network to an external device.

14. A feeding station comprising:
an enclosure including an enclosure base, an enclosure top, at least one opening within the enclosure base and at least one anchoring structure for securing the enclosure to an external element;
at least one reinforced entry frame configured to attach to the at least one opening of the enclosure, the at least one reinforced entry frame sized to allow access into the enclosure for a target species whilst excluding access into the enclosure for a non-target species;
a feeding tray housed within the enclosure; and
a refillable hopper housed within the enclosure, the refillable hopper in communication with the feeding tray and configured to dispense fertility control feed into the feeding tray.

15. The feeding station of claim 14, further comprising a plurality of interchangeable entry frames configured to attach to the at least one opening, wherein each of the plurality of interchangeable entry frames are sized differently to allow access into the enclosure for variously sized said target species.

16. The feeding station of claim 14, wherein the enclosure includes two openings disposed at opposite first and second sides of the enclosure at a first end of the enclosure, wherein the feeding tray is disposed at a second end of the enclosure, opposite the two openings, and wherein the feeding station further comprises two ramps disposed within the enclosure at said opposite first and second sides of the enclosure, the two ramps each connecting one of the two openings to the feeding tray.

17. The feeding station of claim 14, further comprising a removable tray for insertion into the enclosure, wherein the removable tray includes a motion activated camera system configured to monitor activity within the enclosure, and wherein the motion activated camera system includes a microcontroller, a NoIR lens, near-infrared LED lights and a battery pack.

18. The feeding station of claim 14, further comprising a force sensor disposed underneath the refillable hopper to monitor a weight of the feed within the refillable hopper, and wherein the force sensor is configured to transmit sensor data over a communication network to an external device.

19. A method of delivering fertility control feed to a target species, the method comprising:
providing a feeding station comprising:
an enclosure, the enclosure including at least one opening sized to allow access into the enclosure for the target species whilst excluding access into the enclosure for a non-target species;
a feeding tray housed within the enclosure; and
a refillable hopper housed within the enclosure and in communication with the feeding tray;
filling the refillable hopper with the fertility control feed; and
dispensing the fertility control feed into the feeding tray;
wherein the target species are guided through the at least one opening toward the feeding tray where the target species eat the fertility control feed; and
wherein as the feeding tray empties, the refillable hopper refills the feeding tray, enabling delivery of the fertility control feed to the target species on a recurring basis.

20. The method of claim 19, wherein the feeding station further comprises at least one anchoring structure located on the enclosure, and wherein the method further comprises:
securing the enclosure to an external element via the at least one anchoring structure.
